(19) United States
(12) Patent Application Publication
(10) Pub. No.: US 2004/0044949 A1
(43) Pub. Date: Mar. 4, 2004

(54) Document delivery application

(75) Inventor: Robert P. Rowe, Maple Grove, MN (US)

Correspondence Address: LEFFERT JAY & POLGLAZE, P.A., P.O. BOX 581009, MINNEAPOLIS, MN, 55458-1009, US

(73) Assignee: ADC Telecommunications, Inc.

(21) Appl. No.: 10/229,498

(22) Filed: Aug. 28, 2002

(51) Int. Cl. G06F 17/00; G06F 17/24; G06F 17/21

(52) U.S. Cl. 715/500

(57) ABSTRACT

An apparatus and method is described that allows for automatic generation and delivery of customized documents upon request over a network, increasing efficiency and response time of document generation while reducing the number of personnel required for document handling. The improved device apparatus and method also allows for creation of a matter number in a database and entry of the executed and returned document. The improved device apparatus and method additionally allows for tracking of the generated document and automatic generation of reminders after a selected time period for the requestor via electronic mail or webpage.

### TECHNICAL FIELD

The present invention relates generally to automatic document generation and in particular the present invention relates to an application for customized document generation and delivery over a network.

### BACKGROUND

Many organizations, corporations, or departments (referred to herein as organizations) handle documents, contracts, and forms (referred to herein as documents) that are highly similar and vary little in structure from occasion to occasion with the exception of subject matter and/or information they contain. In many cases, these documents require a non-trivial amount of manual handling by organization personnel as information is copied into forms or templates to custom generate each document for a requested purpose. Additionally, in many cases a matter number or file must be opened, filled, and tracked by the organization staff for each subject and/or generated document, such as with personnel or legal documents. This can unnecessarily drain an organization's resources, particularly where there is a high volume of documents that need to be generated and/or where reduced levels of staffing are available. Additionally, the high volume or reduced organization staff can lead to delays in handling each document that is detrimental to the document's requested purpose. Examples of such documents include, but are not limited to contracts, purchase agreements, non-disclosure agreements, reimbursement requests, health insurance forms, records of invention, etc.

In many situations the person or entity requesting the document (referred to herein as the requester) has a limited amount of time that they can wait for the generated document to be returned to them, and/or cannot predict the document need or its contents with a large amount of lead time to compensate for document processing delays. These circumstances are organizationally inefficient and can result in lost opportunity and/or productivity for the requester. Additionally, in many cases this delay in document generation and delivery can cause critical problems and/or loss of a business opportunity.

Many modern document generation systems coupled to computer systems and networks allow for the generation of documents. However, these document server systems generally do so from pre-populated databases of information or pre-existing document templates that exist as part of the document generation system and do not customize the document for its end purpose.

For the reasons stated above, and for other reasons stated below which will become apparent to those skilled in the art upon reading and understanding the present specification, there is a need in the art for a method and apparatus for automatically generating customized documents and, in particular, automatically generating customized documents and populating databases with the submitted information.

### SUMMARY

The above-mentioned problems with generating and handling similar documents and submitted information in organizations are addressed by embodiments of the present invention and will be understood by reading and studying the following specification.

Embodiments of the present invention automatically generate and deliver customized documents to a requestor, increasing efficiency and response time of document generation while reducing the number of personnel required for document handling. This is accomplished by the submission of an electronic document request form to a document server over a network from a requestor via electronic mail (Email) or hyper text transfer protocol (HTTP) for a specific customized document to be generated. Information from the submitted form is incorporated into the document template and the document is generated and delivered to the requestor over the network, typically via an Email or a HTTP webpage. Further, when a request form is submitted a case/matter number is opened and the submitted request information is stored in a database under the case/matter number.

In one embodiment, a method for automatically generating and delivering a customized document is provided. The method receives a request for a specific document via submission of a document request form to a document server over a network from a requester via electronic mail (Email) or hyper text transfer protocol (HTTP) for a document to be generated. The method extracts the information from the submitted form and incorporates it into a document template to generate a document and creates a case/matter number and populates a database/document tracking system with submitted information. The method then delivers the generated document to the requester over the network, typically via an Email or a HTTP webpage. In another embodiment, the method generates a reminder to the requestor and/or an administrator for a status update on an unexecuted document in a selected time interval from the original request.

Other embodiments are described and claimed.

### BRIEF DESCRIPTION OF THE DRAWINGS

FIG. 1 is a simplified diagram of a computer system incorporating an automatic document generation and delivery system according to one embodiment of the present invention.

FIG. 2 is a simplified flowchart of an automatic document generation and delivery system algorithm according to one embodiment of the present invention.

FIG. 3 is a simplified flowchart of an automatic document generation and delivery system algorithm according to one embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention automatically generate and deliver via Email or HTTP webpage customized documents that are produced upon receipt, over a network, of an electronic document request from a requester. This improves the timeliness of document generation and delivery for the document requestor and increases overall efficiency of the organization generating the document. Additionally, embodiments of the present invention reduce the number of personnel required for document handling. Embodiments of the present invention also allow for creation of a case or matter number in a database/document system upon document request and allow for entry of information submitted with the document request into the database/document system. One embodiment of the present invention also allows for the entry of the executed and returned document into the database/document system. Another embodiment of the present invention additionally allows for status tracking of the generated document and automatic generation of reminders after a selected time period for system administrators and/or the requestor via electronic mail or webpage. One embodiment of the present invention allows for encrypted delivery of the generated document. Another embodiment of the present invention also allows for the entry of the electronic execution of the generated document by digital signature and automatic entry of the returned document into the database/document system.

Embodiments of the present invention utilize several types of electronic mail (Email) and hypertext transfer protocol (HTTP) protocols and Email/HTTP servers and clients to transfer, interpret, and display requests, forms, documents, and messages.

HTTP protocols range from the above mentioned “hypertext transfer protocol” (HTTP) to “hypertext transfer protocol secure” (HTTPS) that utilizes a “secure socket layer” (SSL) encrypting transfer protocol and can be further combined with digital certificates for verification. However, HTTP protocols generally involve transferring encoded text, forms, and graphic documents across networks from a webserver (e.g., a document server) to remote recipients for display, download, and input. HTTP transmission generally occurs form program called a “webserver” that executes on a computer or network device that is coupled to a network. HTTP reception and document viewing and interaction is generally done with a program called a “browser” that also executes on a computer typically coupled to a network (e.g., the client computer). Generally, HTTP transfers “hypertext markup language” (HTML) for viewing and interaction with a browser.

Many webserver and content processing programs exist that enable network document serving and document processing on multiple platforms. These platforms range from, but are not limited to, personal computers (PC), personal computer servers, Unix servers, to specialized embedded webservers. Examples of these programs include, but are not limited to, MICROSOFT INTERNET INFORMATION SERVER ™ and MICROSOFT ACTIVE SERVER PAGES ™ by Microsoft, Inc. of Redmond, Wash. USA, COLDFUSION ™ by Macromedia, Inc. of San Fransico, Calif., and the Apache HTTP Server by The Apache Software Foundation, Forest Hill, Md.

Additionally, many browser programs and appliances exist that enable document viewing on multiple platforms. These platforms range from, but are not limited to, web enabled cell phones, personal digital assistants (PDA), personal computers (PC), Unix workstations, specialized web appliances, web enabled televisions and set-top boxes, to text based terminals with a text rendering web browser. Examples of these programs include, but are not limited to, MICROSOFT INTERNET EXPLORER ™ by Microsoft, Inc. of Redmond, Wash. USA, NETSCAPE NAVIGATOR ™ by Netscape Communication Corporation of Mountain View, Calif. USA, NSCA Mosaic by the National Center for Supercomputing Applications at the University of Illinois at Urbana—Champaign, Ill., USA, and Lynx by the University of Kansas at Lawrence, Kans. USA. In addition, most browsers can be combined with add-in modules that can allow many sub-protocols to be delivered over HTTP providing for display of and input to other formatted documents, forms, and files. Examples of such formatted documents, forms, and files include, but is not limited to, “extensible markup language” (XML), “standard graphic markup language” (SGML), Macromedia Flash, Adobe PDF, and Microsoft Word documents. Browsers also allow for interactive documents and interaction with the end user with such technologies and embedded scripts and programming as Javascript, Visual Basic Script, Flash, and “dynamic hypertext markup language” (DHTML). Browsers and webservers also allow for downloading or uploading of documents and binary files.

There are also many forms of Email protocol that are utilized with embodiments of the present invention that range from simple mail transfer protocol (SMTP) to MICROSOFT EXCHANGE ™ by Microsoft, Inc. of Redmond, Wash. USA. However, Email protocol generally involves transferring text across networks from a message sender (e.g., a document server) to remote recipients for display. Email sending, receiving and viewing is generally done with an Email client program that executes on a computer typically coupled to a network (e.g., the client computer). Many Email protocols and message formats also allow documents to be encoded in HTML for viewing and interaction within the Email client program. Additionally, many Email protocols and message formats allow documents to be “attached” to the message by encapsulation.

It is noted that other manners of information transfer over networks exist that can operate with embodiments of the present invention and should be apparent to those skilled in the art with the benefit of the present disclosure.

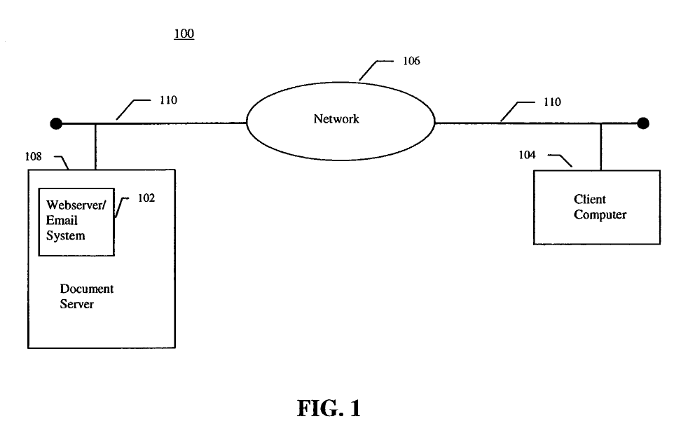

FIG. 1 shows a simplified diagram of a computer system 100 embodiment of the present invention with a document server 108 in communication with a client computer 104 over a network 106. In FIG. 1, the document server 108 is shown incorporating a webserver or Email system 102 and is coupled to the network 106 by a local network segment 110. The client computer 104 is also coupled the network 106 by a local network segment 110 and executes a browser or Email client program for viewing a request form and entering information for submission to the document server 108 via the webserver or Email system 102.

In operation, the computer system 100 of FIG. 1, receives a request for a specific document to be generated via submission of a document request form to the document server 108 over the network 106 from a requestor (on the client computer 104) via Email or HTTP webpage. The document server 108 extracts the document information from the submitted request form and incorporates it into a document template to generate a customized document. The document server 108 then delivers the generated document to the requestor at the client computer 104 over the network 106, via an Email or a HTTP webpage. The requestor then retrieves the generated document (by opening the attached generated document or downloading the generated document from the indicated HTTP webpage) and prints out a hard copy of the document. The hard copy is then executed by the requestor by filling in the remaining missing data, if any, and having it signed, if necessary, by all parties concerned. The executed document is then returned to the organization maintaining the document server 108 for post processing and/or filing. It is noted that the generated document can be in many formats, including, but not limited to, ASCII text, Postscript, Microsoft Word, and Adobe PDF.

In another embodiment, the document server 108 of FIG. 1 creates a case or matter number in a database/document tracking system upon receipt of the document request and enters any information submitted with the document request into the database/document system. This further eliminates additional manual handling/processing by organization staff personnel. In an additional embodiment, this database/document tracking system is updated with information from the executed document when it is returned to the issuing organization. Another embodiment of the present invention also allows for the electronic execution of the generated document by digital signature and the automatic entry of the returned document into the database/document system.

In one embodiment the form submitted by the document requester is interactive and extracts the submitted document information utilizing a series of form pages. Further, the form pages are progressive in that they extract differing information depending on previously answered request information. In another embodiment, the document server 108 upon creating a case or matter number, with the receipt of the document request, that enables the request of additional customized supporting documents for the case or matter number by the requester. In one embodiment, the document server 108 allows for status tracking of the generated document and automatic generation of reminders after a selected time period for system administrators and/or the requestor via electronic mail or webpage. An additional embodiment of the present invention allows for selected encrypted delivery of the generated document at the discretion of the administrator(s) of the document server 108, at the option of the document requestor, or in a destination dependent manner.

Software routines that initialize and operate document servers 108 and client computers 104, such as in the computer system 100 of FIG. 1, are typically stored on a variety of non-volatile machine usable storage mediums that include, but are not limited to, a non-volatile Flash memory, a read only memory (ROM), an electrically erasable programmable read only memory (EEPROM), a one time programmable (OTP) device, a complex programmable logic device (CPLD), an application specific integrated circuit (ASIC), a magnetic media disk, optical media, CD-ROM, etc. It is also noted that computer systems incorporating embodiments of the present invention can take multiple other physical forms, including, but not limited to, computer systems that are functions of other systems, or computer systems that have the document generation functionality expressed in firmware or even hard-coded in a device such as an application-specific integrated circuit (ASIC) chip.

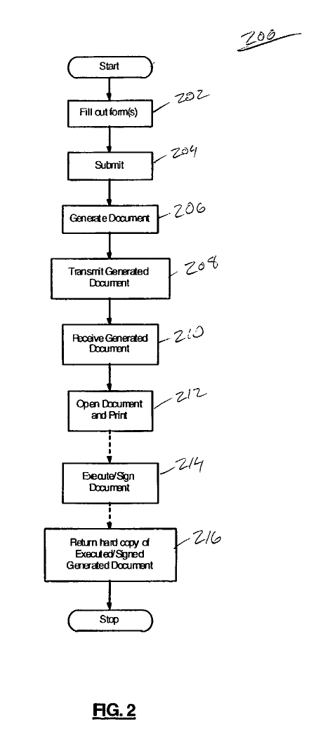

FIG. 2 is a simplified flowchart of a document generation and delivery system algorithm 200 according to one embodiment of the present invention. In the document generation and delivery system algorithm 200 of FIG. 2, a document request form is filled out by a requester 202 and submitted 204 to a document server 108. The document server 108 receives the submitted request form and generates 206 the requested document utilizing the submitted document information contained in the form and a document template. The generated custom document is transmitted 208 back to the document requestor via an Email, an Email attachment, or a download link posted on an HTTP webpage. The document requestor receives the generated document 210 via Email message or an updated HTTP webpage and then opens and prints the document 212 into a hard copy format. Hard copy format handling is noted by a dashed line in the flowchart 200. Any remaining required information on the hard copy document is then filled in by the requester and the document is executed 214, if required, by all parties signing the document. The executed hard copy document is then returned 216 to the organization operating the document server 108 and it is processed and/or filed.

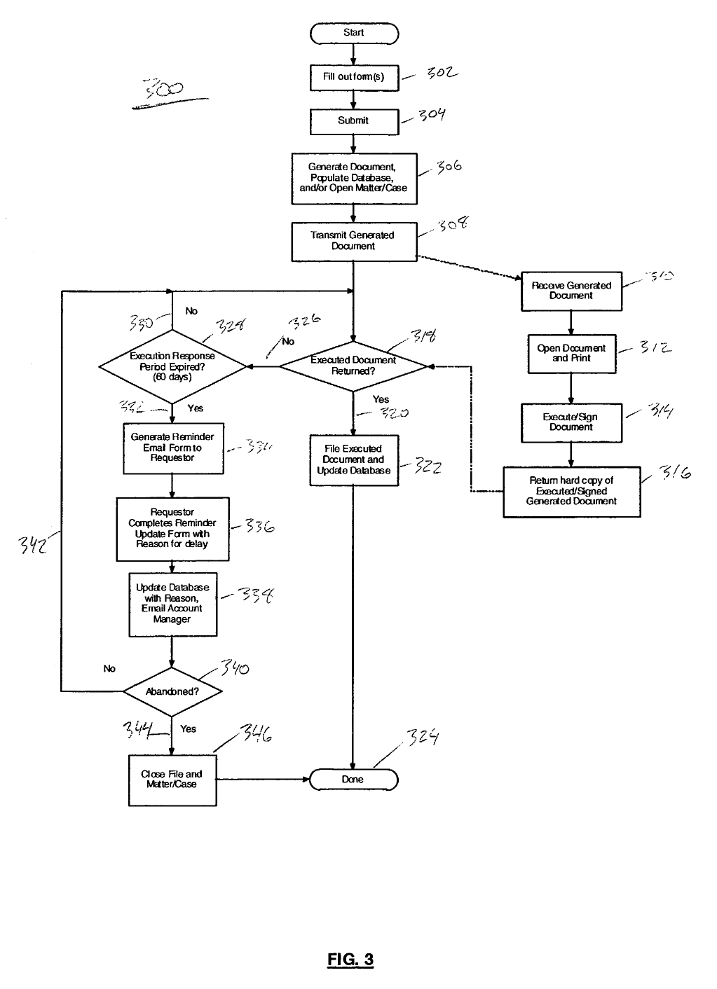

FIG. 3 is a simplified flowchart of a document generation and delivery system algorithm 300 according to another embodiment of the present invention. In the document generation and delivery system algorithm 300 of FIG. 3, a document request form is filled out by a requestor 302 and submitted 304 to a document server 108. The document server 108 receives the submitted request form and generates 308 the requested document utilizing the submitted document information contained in the form and a document template. When the requested customized document is generated 308 the document server 108 also opens a case/matter number for the request and populates an associated database with the document information submitted with the request. The generated custom document is then transmitted 308 back to the document requestor via an Email, an Email attachment, or a download link posted on an HTTP webpage. The document requestor receives the generated document 310 via Email message or an updated HTTP webpage and then opens and prints the document 312 into a hard copy format. Any remaining required information on the hard copy document is then filled in by the requester and the document is executed 314, if required, by all parties signing the document. The executed hard copy document is then returned 316 to the organization operating the document server 108.

After the generated document has been transmitted 308 to the document requester, the document generation and delivery system algorithm 300 waits 318 for the executed document to be returned. When the executed document is returned 320 the associated database is updated and the executed document is filed 322 and the algorithm finishes 324. It is noted that the updating of information contained in the database with the returned document 322 can include, but is not limited to, updating the database that the document was executed and returned, recording the date of return/execution, recording the executing parties, recording specific information from the document, or storing an electronic or scanned copy of the executed document, depending on the information that is required. It is also noted that the updating of the database with the returned document 322 can be by either manual entry of the pertinent information from the returned document or electronic entry of the information depending on if the generated document is either physically or electronically returned after being executed. If the executed document has not been returned 326, the document generation and delivery system algorithm 300 periodically checks to see if a selected response time has expired 328. When the selected response time period has not expired, the document generation and delivery system algorithm 300 returns 330 to continue to wait for the document return 318. When the selected response time has expired 332, the document generation and delivery system algorithm 300 generates a reminder Email or HTTP webpage notice form 334 to the document requestor. The requestor completes the reminder form with reason for the document execution delay 336 and submits it back to the document server 108. The document server 108 updates the database with the reason for the delay and the account manager is optionally Emailed with the update information 338. If the reason for the delay is due to the document has been abandoned 344, the document generation and delivery system algorithm 300 closes the case/matter number and file 346 and the algorithm finishes 324. If the document has not been abandoned 342, the document generation and delivery system algorithm 300 returns to wait for the return of the executed document 318.

Alternative computer system and device embodiments of the present invention with a document generation and delivery system and/or method will be apparent to those skilled in the art with the benefit of the present disclosure, and are also within the scope of the present invention.

### Conclusion

An apparatus and method have been described that allows for automatic generation and delivery of customized documents upon request over a network, increasing efficiency and response time of document generation while reducing the number of personnel required for document handling. The improved device apparatus and method also allows for creation of a matter number in a database and entry of the executed and returned document. The improved device apparatus and method additionally allows for tracking of the generated document and automatic generation of reminders after a selected time period for the requester via electronic mail or webpage.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of automatically generating a document, comprising:
receiving an electronic form containing document information from a requestor;
generating a document with the document information;
sending the generated document to the requestor;
executing the generated document;
returning the executed document; and
updating a database with the executed document.

2. The method of claim 1, wherein receiving an electronic form containing document information from a requestor further comprises the requestor filling out the form and submitting the form over a network.

3. The method of claim 2, wherein the form further comprises an interactive form that selectively extracts differing information from the requester according to the nature of the request.

4. The method of claim 1, wherein generating a document with the document information further comprises opening a matter number for the document information.

5. The method of claim 4, wherein generating a document with the document information further comprises allowing the requester to request supporting document generation with opening a matter number for the document information.

6. The method of claim 1, wherein generating a document with the document information further comprises inserting the document information in a database.

7. The method of claim 1, wherein generating a document with the document information further comprises generating a document and associated document instructions with the document information.

8. The method of claim 1, wherein sending the generated document to the requestor further comprises sending the generated document to the requestor by placing the generated document on a webpage.

9. The method of claim 1, wherein sending the generated document to the requestor further comprises sending the generated document to the requester by sending the generated document in an email.

10. The method of claim 1, wherein sending the generated document to the requestor further comprises selectively encrypting the generated document.

13. The method of claim 1, wherein executing the generated document further comprises executing the generated document with a digital signature.

14. A method of operating a computer system, comprising:
receiving an electronic form containing submitted information from a requestor;
populating a database with the submitted information;
generating a document with the submitted information;
sending the generated document to a destination;
executing the generated document;
returning the executed document; and
updating the database.

15. The method of claim 14, wherein receiving an electronic form containing submitted information from a requestor further comprises the requestor filling out the form and submitting the form over a network.

16. The method of claim 15, wherein the form further comprises an interactive form that selectively extracts submitted information from the requestor in response to one or more submitted information inputs of the requestor.

17. The method of claim 14, wherein generating a document with the submitted information further comprises opening a case for the submitted information.

18. The method of claim 17, wherein generating a document with the submitted information further comprises enabling the requestor to further request additional document generation that is in support of the generated document when a case has been opened.

19. The method of claim 14, wherein generating a document with the submitted information further comprises generating a document and document instructions that are specific to the generated document with the submitted information.

20. The method of claim 14, wherein sending the generated document to a destination further comprises sending the generated document to a requester.

21. The method of claim 14, wherein sending the generated document to the requester further comprises sending the generated document to the requestor by placing the generated document on a webpage.

22. The method of claim 14, wherein sending the generated document to the requester further comprises sending the generated document to the requestor by sending the generated document in an email.

23. The method of claim 14, wherein sending the generated document to the requestor further comprises selectively encrypting the generated document.

26. The method of claim 14, wherein executing the generated document further comprises executing the generated document with a digital signature.

27. The method of claim 14, wherein returning the executed document further comprises sending a reminder to the requestor if a selected time period has passed and the executed document has not been returned.

28. The method of claim 27, wherein sending a reminder to the requestor further comprises sending a reminder that has a form that allows the requestor to state the reason for any delay.

29. The method of claim 27, wherein sending a reminder to the requester further comprises updating the database with a response from the requestor.

30. The method of claim 29, wherein updating the database with a response from the requestor further comprises closing the case if the response from the requestor indicates the matter has been abandoned.

31. A machine-usable medium having machine-readable instructions stored thereon for execution by a processor to perform a method comprising:
receiving an electronic form through a network interface containing submitted information from a requestor;
populating a database with the submitted information;
generating a document with the submitted information;sending the generated document to a destination through the network interface;
executing the generated document;
returning the executed document; and
updating the database.

32. The machine-usable medium of claim 31, wherein receiving an electronic form containing submitted information from a requestor further comprises the requestor filling out the form and submitting the form over a network.

33. The machine-usable medium of claim 31, wherein generating a document with the submitted information further comprises opening a case for the submitted information.

34. The machine-usable medium of claim 31, wherein sending the generated document to the requestor further comprises sending the generated document to the requestor by placing the generated document on a webpage.

35. The machine-usable medium of claim 31, wherein sending the generated document to the requestor further comprises sending the generated document to the requestor by sending the generated document in an email.

38. The machine-usable medium of claim 31, wherein returning the executed document further comprises sending a reminder to the requester if a selected time period has passed and the executed document has not been returned.

39. The machine-usable medium of claim 38, wherein sending a reminder to the requestor further comprises sending a reminder that has a form that allows the requestor to state the reason for any delay.

40. The machine-usable medium of claim 38, wherein sending a reminder to the requester further comprises updating the database with a response from the requestor.

41. A computer system, comprising:
a communication link; and
a plurality of computing devices coupled to the communication link, wherein at least one of the plurality of computing devices comprises:
a processor;
a network interface coupled to the communication link and the processor, wherein the network interface communicates on the communication link utilizing a communication protocol; and
wherein the processor is adapted to:
receive a form through the network interface containing submitted information from a requestor;
populate a database with the submitted information;
generate a document with the submitted information;
send the generated document to a destination through the network interface;
receive the executed generated document; and
update the database.

42. The computer system of claim 41, wherein at least one of the plurality of computing devices transmits the form via the communication link.

43. The computer system of claim 41, wherein the processor receiving a form containing submitted information from a requester further comprises the requestor filling out the form and submitting the form over a network.

44. The computer system of claim 41, wherein the processor generating a document with the submitted information further comprises the processor opening a case for the submitted information.

45. The computer system of claim 41, wherein the processor sending the generated document to the requestor further comprises the processor sending the generated document to the requestor by placing the generated document on a webpage.

46. The computer system of claim 41, wherein the processor sending the generated document to the requestor further comprises the processor sending the generated document to the requester by sending the generated document in an email.

48. A document server, comprising:
a processor;
a network interface coupled to the processor, wherein the network interface communicates utilizing a communication protocol; and
wherein the processor is adapted to:
receive a form through the network interface containing submitted information from a requestor;
populate a database with the submitted information;
generate a document with the submitted information;
send the generated document to a destination through the network interface;
receive the executed generated document; and
update the database.
